(19) United States
(12) Patent Application Publication
(10) Pub. No.: US 2016/0187501 A1
(43) Pub. Date: Jun. 30, 2016

(54) THIN-LAYER CHROMATOGRAPHY TYPE RADIATION DETECTOR

(71) Applicant: Korea Institute of Radiological & Medical Sciences, Seoul (KR)

(72) Inventors: Jong Guk Kim, Seongnam-si (KR); Sang June Jeon, Seoul (KR); Jung Young Kim, Namyangju-si (KR); Kyeong Min Kim, Seoul (KR)

(73) Assignee: Korea Institute of Radiological & Medical Sciences, Seoul (KR)

(21) Appl. No.: 14/921,934

(22) Filed: Oct. 23, 2015

(30) Foreign Application Priority Data
Dec. 29, 2014 (KR) 10-2014-0192559

(51) Int. Cl. G01T 1/203; G01T 1/20

(52) U.S. Cl. CPC G01T 1/2033; G01T 1/2018; G01T 1/2002

(57) ABSTRACT

A thin-layer chromatography type radiation detector includes a plurality of light-emitting members configured to generate visible light due to radiation, each of the light-emitting members including a scintillator having a surface filled with a reflector for reflecting the visible light, and are arranged in parallel to one another in a width direction, light sensors respectively coupled to one end portions of the plurality of light-emitting members and configured to measure a current generated due to the visible light generated by the plurality of light-emitting members, and an output port configured to sequentially output values of the current measured by the light sensors as digital signals.

### CROSS-REFERENCE TO RELATED APPLICATION

This application claims the benefit of Korean Patent Application No. 10-2014-0192559, filed on Dec. 29, 2014, in the Korean Intellectual Property Office, the disclosure of which is incorporated herein in its entirety by reference.

### BACKGROUND

1. Field

One or more exemplary embodiments relate to a detector that may detect a variation generated in a variety of liquid nuclear materials by using chromatography.

2. Description of the Related Art

In general, a radiation detector is used to detect radiation and to measure the type, intensity, energy distribution, and human exposure dose of radiation transmitted from a radioactive material to a human.

A representative radiation detector is a Geiger counter. The Geiger counter measures the amount of electric charges generated by ionization of a gas due to radiation. Another radiation detector detects light generated as atoms collide with electrons or other particles due to radiation and thus the energy levels of particles are changed.

The inventive concept relates in particular to a detector for measuring radiation generated in a liquid nuclear material. In order to measure the radiation generated in a liquid nuclear material, chromatography is typically used. Chromatography is a method of measuring the distribution of radioactive materials by applying a liquid radioactive solvent onto a thin plate and separating chemical components while materials in the liquid radioactive solvent move over the thin plate at different rates.

A method of detecting radiation by using chromatography is disclosed in Korean Patent Publication No. 1991-0010187.

A conventional thin-layer chromatography type radiation detector uses a method using an ionization chamber in which radiation is detected by using ionization of a gas and a method using a scintillation detector in which a scintillation crystal for generating visible light due to radiation is combined with a photo-multiplier tube (PMT).

A method using an ionization chamber may be used to measure an entire area of a sample at one time and may be used to measure both a beta source and a gamma source. However, the method using the ionization chamber has disadvantages in that the efficiency thereof is reduced when a gamma source having high energy is measured and P-10 gas has to be continuously injected while the radiation detector is used.

A method using a scintillator and a PMT may efficiently measure a gamma source having high energy. However, the method using the scintillator and the PMT has disadvantages in that an entire area of a sample may not be measured at one time and a surface of the sample has to be scanned at a low speed.

A conventional radiation detector scans radioactive materials separated by a thin plate while moving on a plane. However, the conventional radiation detector has a disadvantage in that the distribution of the radioactive materials separated by the thin plate may not be measured at a high resolution. Also, since the conventional radiation detector is manufactured to measure only one nuclide, the conventional radiation detector may not detect a variety of nuclides. Also, since the conventional radiation detector uses ionization and thus a gas has to be continuously supplied to the conventional radiation detector, a structure of the conventional radiation detector may be complex and manufacturing costs may be high.

In order to overcome these disadvantages, the inventive concept provides a thin-layer chromatography type radiation detector that has a simple structure and low manufacturing costs by using a scintillator and a light sensor, instead of gas, may analyze the distribution of radioactive materials separated by chromatography on a plane, and may have a higher resolution than that of the conventional radiation detector.

### SUMMARY

Additional aspects will be set forth in part in the description which follows and, in part, will be apparent from the description, or may be learned by practice of the presented embodiments

According to one or more exemplary embodiments, a thin-layer chromatography type radiation detector includes: a plurality of light-emitting members configured to generate visible light due to radiation, each of the light-emitting members comprising a scintillator having a surface filled with a reflector for reflecting the visible light, and arranged in parallel to one another in a width direction; light sensors respectively coupled to one end portions of the plurality of light-emitting members and configured to measure a current generated due to the visible light generated by the plurality of light-emitting members; and an output port configured to sequentially output values of the current measured by the light sensors as digital signals.

The plurality of light-emitting members may have square pillar shapes.

The scintillator may include any one material selected from a synthetic resin scintillator, Gd₂O₂S, ZnS, P, Gd₃Al₂Ga₃O₁₂, Gd₂SiO₅:Ce, Bi₄Ge₃O₁₂, Lu_{1.6}Y_{0.4}SiO₅:Ce, Lu₂SiO₅:Ce, and CsI(Tl).

The reflector may include any one material selected from BaSO₄, TiO₂, MnO, and Al₂O₃.

A portion of the reflector arranged in a direction in which the radiation is incident on each of the plurality of light-emitting members may be a synthetic resin film including polyester-polyethyelene-terephthalate.

The output port may be detachably coupled to an external data obtaining apparatus.

The light sensors may include silicon PIN diodes.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view illustrating a structure of a thin-layer chromatography type radiation detector according to an exemplary embodiment;

FIG. 2 is an exploded perspective view of the thin-layer chromatography type radiation detector of FIG. 1;

FIG. 3 is a cross-sectional view taken along line III-Ill of FIG. 1;

FIG. 4 is a cross-sectional view taken along line IV-IV of FIG. 1;

FIG. 5 is a perspective view illustrating a structure of a thin-layer chromatography type radiation detector according to another exemplary embodiment;

FIG. 6 is a view illustrating a configuration of a radiation detection system including the thin-layer chromatography type radiation detector of FIG. 1;

FIG. 7 is a graph showing results of performance comparison between the thin-layer chromatography type radiation detector of FIG. 1 and a conventional radiation detector; and

FIG. 8 is a table showing values of the graph of FIG. 7.

### DETAILED DESCRIPTION

Reference will now be made in detail to embodiments, examples of which are illustrated in the accompanying drawings.

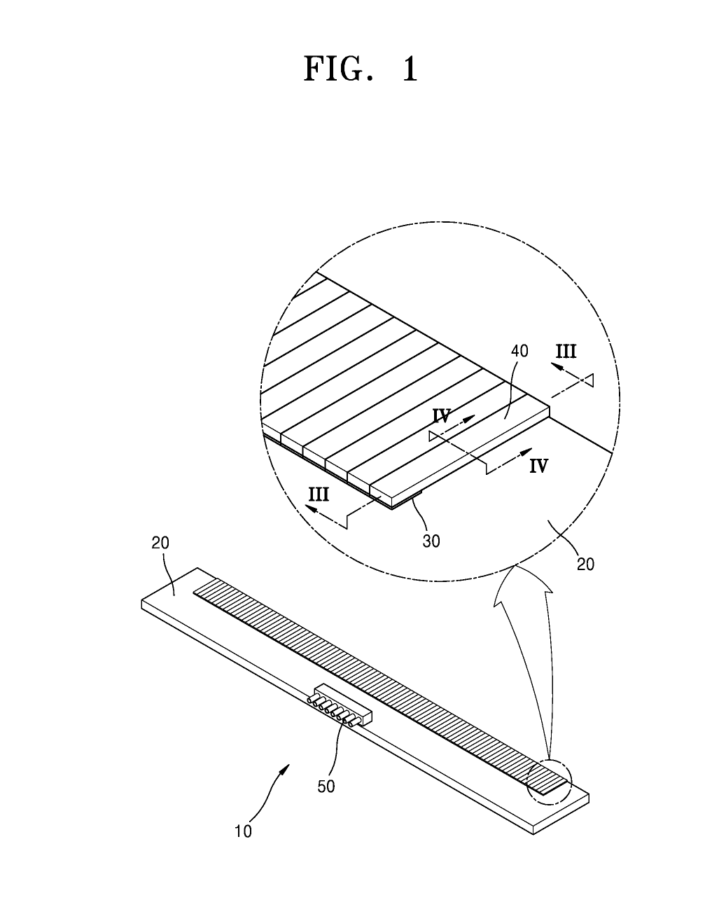

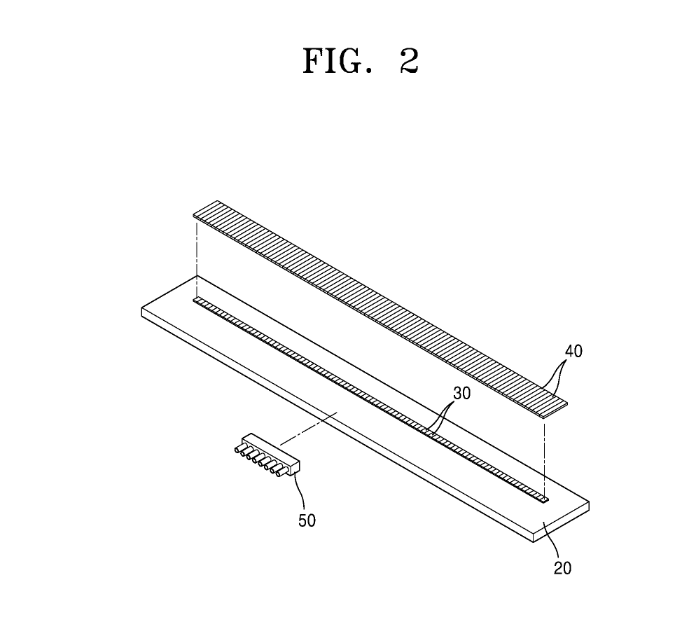

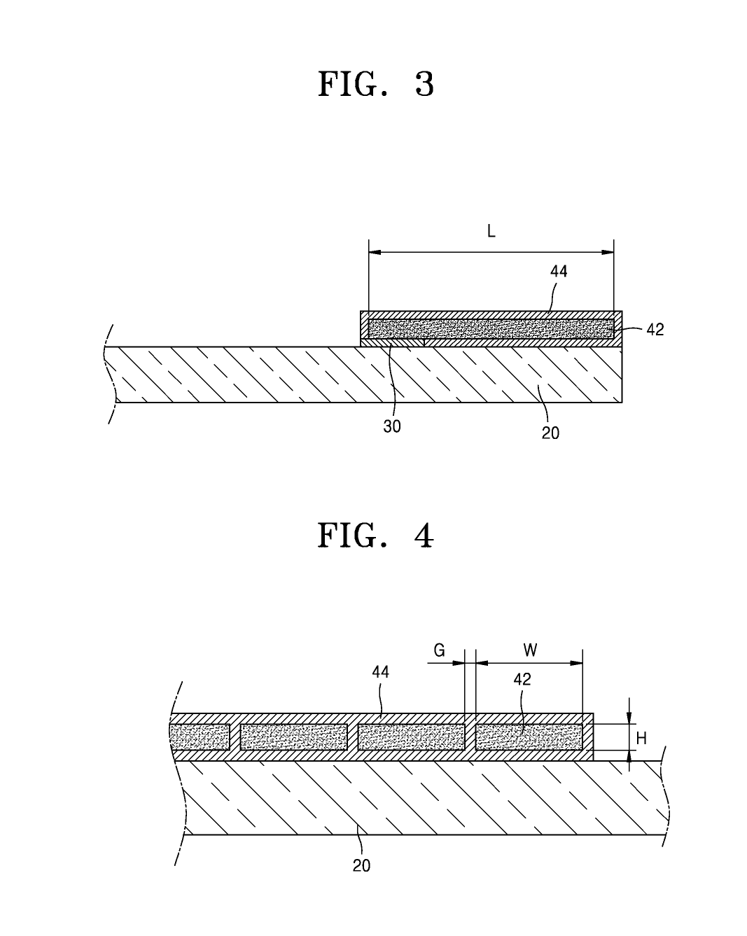

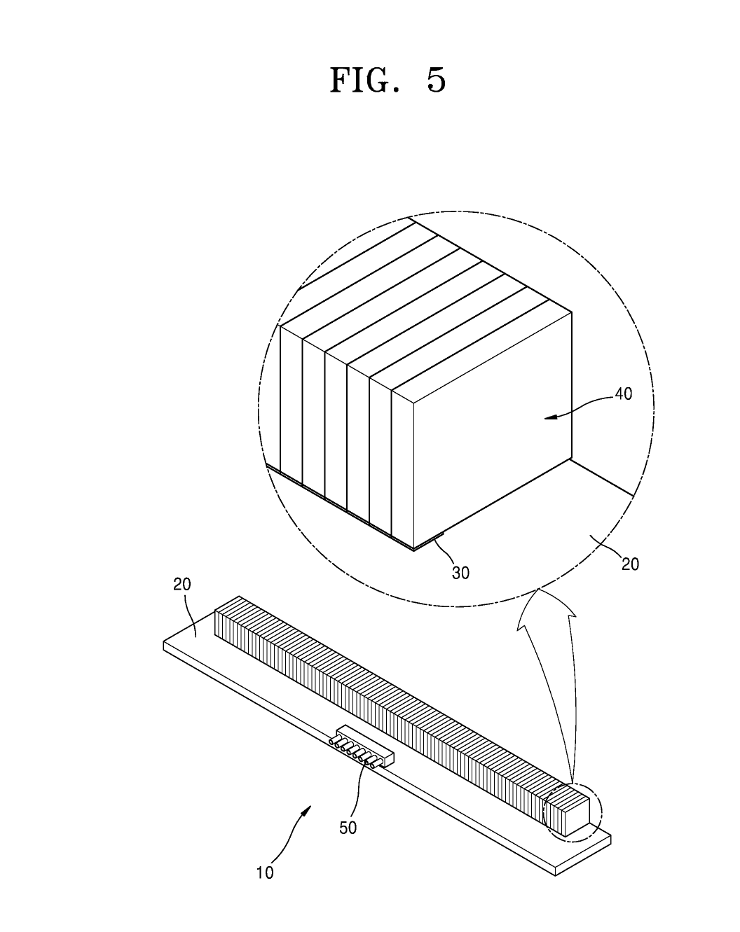

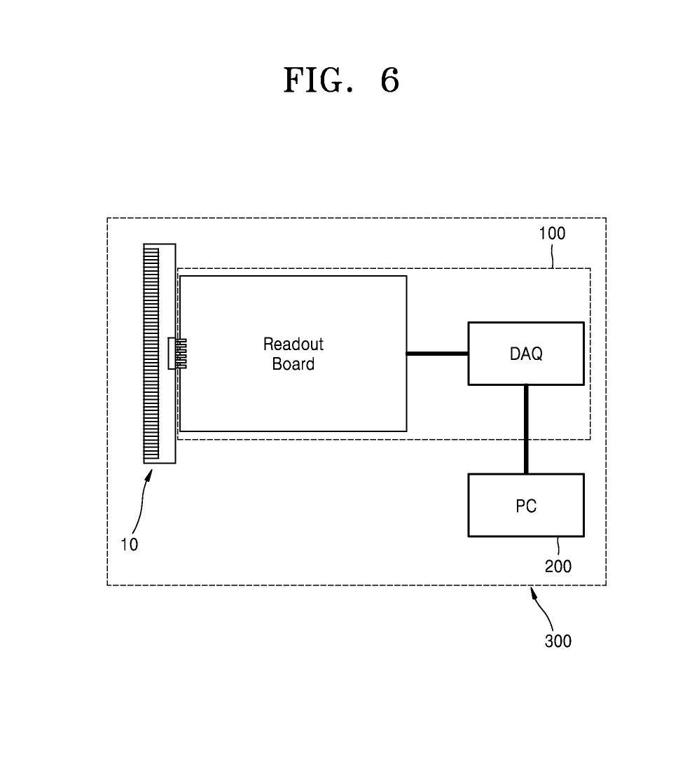

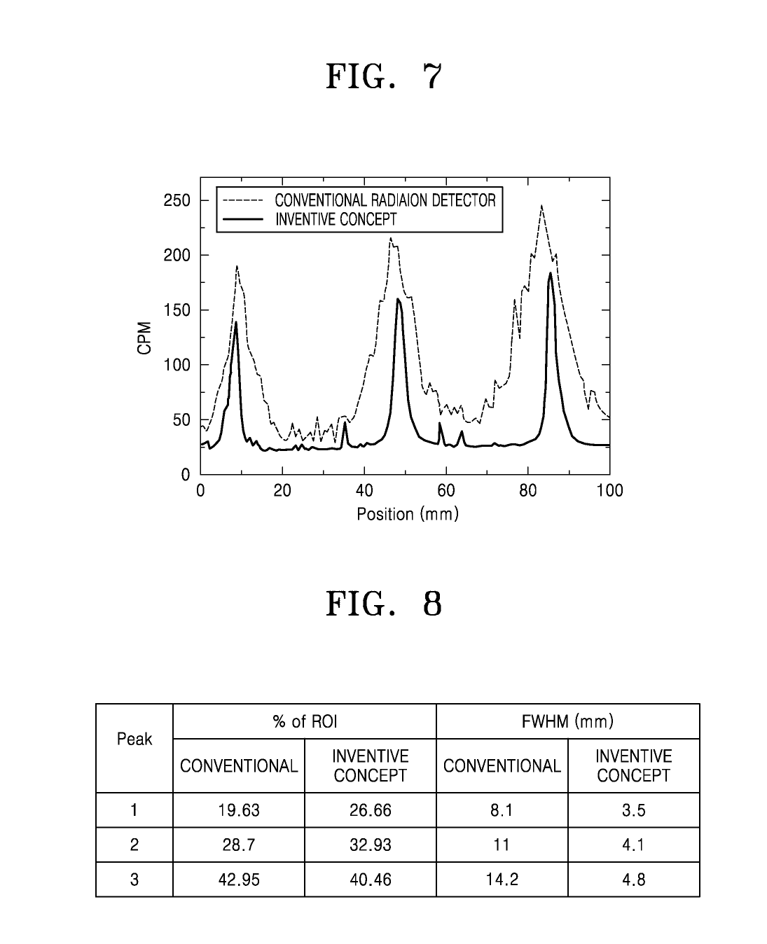

FIG. 1 is a perspective view illustrating a structure of a thin-layer chromatography type radiation detector according to an exemplary embodiment. FIG. 2 is an exploded perspective view of the thin-layer chromatography type radiation detector of FIG. 1. FIG. 3 is a cross-sectional view taken along line III-Ill of FIG. 1. FIG. 4 is a cross-sectional view taken along line IV-IV of FIG. 1. FIG. 5 is a perspective view illustrating a structure of a thin-layer chromatography type radiation detector according to another exemplary embodiment. FIG. 6 is a view illustrating a configuration of a radiation detection system including the thin-layer chromatography type radiation detector of FIG. 1. FIG. 7 is a graph showing results of performance comparison between the thin-layer chromatography type radiation detector of FIG. 1 and a conventional radiation detector. FIG. 8 is a table showing values of the graph of FIG. 7.

Referring to FIGS. 1 through 8, a thin-layer chromatography type radiation detector (hereinafter, referred to as a “radiation detector”) 10 according to an exemplary embodiment may include a body 20, light sensors 30, light-emitting members 40, and an output port 50.

The body 20 may be formed of a synthetic resin material having a plate shape. The body 20 is provided so that the light sensors 30, the light-emitting members 40 and the output port 50 may be provided on the body 20.

The light sensors 30 are arranged on one surface of the body 20. A plurality of the light sensors 30 are provided. The light sensors 30 detect the amount of visible light and output the detected amount of visible light as digital current. The light sensors 30 are arranged to be spaced apart from one another. The light sensors 30 include silicon PIN diodes. The light sensors 30 measure the amount of visible light that is generated by the light-emitting members 40. The light sensors 30 are respectively coupled to one end portions of the light-emitting members 40 and measure current that is generated due to visible light that is generated by the light-emitting members 40. The light sensors 30 are electrically connected to the output port 50.

The light-emitting members are disposed on the surface of the body 20. A plurality of the light-emitting members are provided. Each of the light-emitting members 40 includes a scintillator 42 that generates visible light due to radiation incident thereon and a reflector 44 that is disposed to cover a surface of the scintillator 42. Each of the light-emitting members 40 is formed to have a square pillar shape. That is, each of the light-emitting members 40 longitudinally extends in one direction. Also, the light-emitting members 40 are spaced apart from one another to be parallel to one another. For example, the number of the light-emitting members 40 may be 64, 128, or 256. Each of the light-emitting members 40 measures an intensity of radiation of a radioactive material at a specific position. The light-emitting members 40 respectively independently transmit signals to the light sensors 30. The surface of the scintillator 42 of each of the light-emitting members 40 is covered by the reflector 44. One end portion of the light-emitting member 40 is coupled to the light sensor 30. A surface of the end portion of the light-emitting member 40 that is coupled to the light sensors 30 is not covered by the reflector 44. Accordingly, it is deemed that visible light that is generated by the light-emitting member 40 is transmitted to the light-emitting member 40 without loss. The scintillator 42 may include any one material selected from, for example, a synthetic resin scintillator, Gd₂O₂S, ZnS, and P. The scintillator 42 receives radiation from radioactive materials separated by chromatography and generates visible light. The synthetic resin scintillator may be made by mixing a solvent such as polystyrene or polyvinyltoluene with a solute such as p-terphenyl, C₁₅H₁₁NO (PPO), or C₂₄H₁₆N₂O (POPOP).

The scintillator 42 may be formed to have a relatively small thickness as shown in FIG. 1, or may be formed to have a relatively large thickness as shown in FIG. 5. The scintillator 42 of FIG. 1 may effectively detect beta rays and the scintillator 42 of FIG. 5 may effectively detect gamma rays.

The light-emitting members 40 may be arranged to be spaced apart from one another, and may each measure the amount of radiation at a specific position as a digital type. That is, a radioactive material that is applied onto one point is separated by chromatography, and a direction in which the radioactive material is separated, that is, the radioactive material travels as time passes, is a width direction of the light-emitting member 40.

Referring to FIG. 1, the scintillator 42 that is suitable to detect beta rays includes a synthetic resin scintillator (e.g., a plastic scintillator), Gd₂O₂S, ZnS, or P. A width W and a height H of the scintillator 42 that may effectively detect beta rays may be respectively 0.7 mm and 0.8 mm. A gap G between the scintillators 42 may be 0.1 mm. A length of the scintillator 42 may range from 10 mm to 20 mm according to a size of a thin-layer chromatography film.

Referring to FIG. 5, the scintillator 42 that is suitable to detect gamma rays includes Gd₃Al₂Ga₃O₁₂, Gd₂SiO₅:Ce, Bi₄Ge₃O₁₂, Lu_{1.6}Y_{0.4}SiO₅:Ce, Lu₂SiO₅:Ce, or CsI(Tl). The width W of the scintillator 42 that may effectively detect gamma rays may be 0.7 mm and the height H of the scintillator 42 may range from 100 mm to 200 mm. The gap G between the scintillators 42 may be 0.1 mm. The length L of the scintillator 42 may range from 10 mm to 20 mm according to a size of a thin-layer chromatography film. In general, since gamma rays have a higher transmittance than that of beta rays, the height H of the scintillator 42 is increased so that the scintillator 42 may sufficiently absorb the gamma rays.

The reflector 44 may be formed as a sintered body by being applied as paste to the surface of the scintillator 42 and then being heated in a heating furnace. The reflector 44 may be formed of, for example, BaSO₄, TiO₂, MnO, or Al₂O₃. A portion of the reflector 44 that is disposed on a surface of the light-emitting member 40 on which radiation is incident may be a synthetic resin film formed of polyester-polyethylene-terephthalate (called a “Mylar” film).

The output port 50 may be disposed on an edge portion of the body 20. The output port 50 sequentially outputs values of current that are measured by the light sensors 30 as digital signals. The output port 50 may include a terminal for supplying power for operating the light sensors 30. The output port 50 may be detachably coupled to a data obtaining module 100 that is an external module. Accordingly, since the radiation detector 10 for detecting beta rays and the radiation detector 10 for detecting gamma rays may be easily exchanged, different types of radiation may be easily detected by using one detection system.

Referring to FIG. 6, a configuration of a radiation detection system 300 including the radiation detector 10 may be easily understood. That is, the radiation detector 10 may be detachably coupled to the data obtaining module 100, and data that is stored in the data obtaining module 100 may be transmitted to an image processing apparatus 200 such as a computer so that a user may observe a distribution of radiation.

An operation and an effect of the radiation detector 10 including the above-described elements will now be explained in detail.

First, referring to FIG. 6, a Tc-99m radiation source was applied by 1 μCi, 1.5 μCi, and 2 μCi onto three points each having diameters of 1 mm of a thin film at intervals of 4 cm to separate materials by using chromatography and then the amount of radiation was measured. In order to compare the performance of the radiation detector 10 according to the present exemplary embodiment with the performance of a conventional radiation detector that was AR-2000 of Eckert & Ziegler, the same sample was used for both the radiation detector 10 and the conventional radiation detector.

Referring to FIGS. 7 and 8, when the amount of radiation of the same sample was measured, it was found that the radiation detector 10 according to the present exemplary embodiment has a sufficiently high region of interest (ROI) value, compared to the conventional radiation detector. In FIG. 7, the horizontal axis represents a distance (or a position (mm)) from an original point during the separation by the chromatography, and the vertical axis represents counts per minute (CPM), that is, the number of radiation detection events in each radiation detector for one minute.

That is, when an intensity of radiation of the same radioactive material was measured, it was found that an ROI value that is a ratio of a width of an ROI to all regions of the radiation detector 10 according to the present exemplary embodiment is similar to that of the conventional radiation detector. That is, the term ‘ROI value’ refers to a ratio of an area between the horizontal axis and a graph of a full width at half maximum (FWHM) of each peak to an area between the horizontal axis and a graph of the peak in FIG. 7. That is, when the ROI value is high, it means that much radioactive material is distributed at the peak. Referring to FIG. 8, since the radiation detector 10 according to the present exemplary embodiment has an ROI value that is similar to that of the conventional radiation detector that is marketed, it is found that the radiation detector 10 is sufficiently excellent in detecting radiation.

Referring to FIGS. 7 and 8, it is found that the radiation detector 10 according to the present exemplary embodiment has a much higher resolution than that of the conventional radiation detector. An FWHM is used as a measure for determining a resolution of a radiation detector. Referring to FIGS. 7 and 8, an FWHM value measured by the radiation detector 10 according to the present exemplary embodiment is less than that measured by the conventional radiation detector. Accordingly, it is found that the radiation detector 10 has a much higher resolution than that of the conventional radiation detector.

A process performed by the radiation detector 10 having a high resolution to detect radiation will now be explained in an order in which the radiation is incident.

First, radiation that is generated in a sample material is incident on the light-emitting members 40. The radiation that is incident on the light-emitting members 40 may be, for example, beta rays or gamma rays. Part of the radiation that is incident on the light-emitting members 40 passes through the light-emitting members 40 to be emitted to the outside whereas a large amount of other part of the radiation transmits energy to an atomic structure of the scintillator 42 of each of the light-emitting members 40 so that the scintillator 42 generates visible light. The visible light that is generated by the scintillator 42 is not emitted to the outside of the scintillator 42 due to the reflector 44 and moves along the light-emitting member 40. The light sensor 30 that is disposed at one end portion of the light-emitting member 40 detects the visible light of the light-emitting member 40 and generates digital current. That is, the digital current that is output by the light-sensor 30 may indicate the amount of radiation that is absorbed by one light-emitting member 40. As such, the light sensor 30 detects the amount of radiation that is absorbed by each of the light-emitting members 40 that are arranged to be spaced apart by fine intervals from one another and sequentially outputs a signal through the output port 50. Data that is output through the output port 50 may be temporarily stored and organized in the data obtaining module 100, and then may be subjected to image processing in the image processing apparatus 200 such as a computer, so that a user may observe a distribution of the radiation.

In a radiation detector according to the one or more exemplary embodiments, unlike in a conventional radiation detector, since a plurality of light-emitting members having square pillar shapes convert a distribution of radiation of liquid radioactive materials that are separated by chromatography into visible light and light sensors measure the visible light and output the measured visible light as digital current through an output port, and thus gas is not used, a structure may be simplified and manufacturing costs may be reduced, and the radiation may be detected at a high resolution by using the light-emitting members. Also, since the radiation detector according to the one or more exemplary embodiments is detachably coupled to a data obtaining module, the radiation detector may be easily replaced according to a type of the radiation to be measured, thereby improving use efficiency.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A thin-layer chromatography type radiation detector comprising:
a plurality of light-emitting members configured to generate visible light due to radiation, each of the light-emitting members comprising a scintillator having a surface filled with a reflector for reflecting the visible light, and arranged in parallel to one another in a width direction;
light sensors respectively coupled to one end portions of the plurality of light-emitting members and configured to measure a current generated due to the visible light generated by the plurality of light-emitting members; and
an output port configured to sequentially output values of the current measured by the light sensors as digital signals.

2. The thin-layer chromatography type radiation detector of claim 1, wherein the plurality of light-emitting members have square pillar shapes.

3. The thin-layer chromatography type radiation detector of claim 1, wherein the scintillator comprises any one material selected from a synthetic resin scintillator, Gd₂O₂S, ZnS, P, Gd₃Al₂Ga₃O₁₂, Gd₂SiO₅:Ce, Bi₄Ge₃O₁₂, Lu_{1.6}Y_{0.4}SiO₅:Ce, Lu₂SiO₅:Ce, and CsI(Tl).

4. The thin-layer chromatography type radiation detector of claim 1, wherein the reflector comprises any one material selected from BaSO₄, TiO₂, MnO, and Al₂O₃.

5. The thin-layer chromatography type radiation detector of claim 1, wherein a portion of the reflector arranged in a direction in which the radiation is incident on each of the plurality of light-emitting members is a synthetic resin film comprising polyester-polyethyelene-terephthalate.

6. The thin-layer chromatography type radiation detector of claim 1, wherein the output port is detachably coupled to an external data obtaining apparatus.

7. The thin-layer chromatography type radiation detector of claim 1, wherein the light sensors comprise silicon PIN diodes.
